(19) United States
(12) Patent Application Publication
(10) Pub. No.: US 2004/0201215 A1
(43) Pub. Date: Oct. 14, 2004

(54) Safety lock for a hose coupling

(76) Inventor: Robert W. Steingass, Valparaiso, IN (US)

Correspondence Address: Daniel N. Christus, Esq., Wallenstein & Wagner, Ltd., 311 South Wacker Drive, 53rd Floor, Chicago, IL, 60606-6630, US

(21) Appl. No.: 10/411,557

(22) Filed: Apr. 10, 2003

(51) Int. Cl. F16L 17/00

(52) U.S. Cl. 285/376

(57) ABSTRACT

A safety lock for a hose coupling is disclosed. The safety lock has a substantially L-shaped lever having a longer upper leg and a shorter lower leg pivotable about a solid post extending from and integral with the coupling. The lever is positioned adjacent a support surface of the coupling, such that the shorter lower leg is within a distance of 0.05 inches or less to the support surface. The safety lock may be formed of a polymer or any material, which when conditioned to a relative humidity of 50% and tested at a temperature of 73° F., has an elongation at yield of at least 10% and a flexural modulus of at least 100,000 psi.

### TECHNICAL FIELD

The present invention relates generally to a safety lock for a coupling, and more particularly, the present invention relates to a safety lock for a water hose coupling that is resistant to permanent deformation and corrosion due to a specially designed and positioned lever that is pivotable about a solid post extending from and integral with the coupling.

### BACKGROUND

Fire fighting requires the use of long lengths of heavy hose that are sometimes connected by means of quick, twist-type coupling systems. Present day coupling systems are designed for speed and ease of use. Many coupling systems can achieve a watertight connection with only a quarter or one-third turn of one of the coupling rims relative to the other coupling rim. The coupling rims are rotatable about each hose end for alignment while the hose remains stationary, so that hose need not be turned to achieve proper coupling.

Modern hose coupling systems are independent of end-to-end orientation, or “androgynous” in nature because each coupling half has both male and female elements. Thus, any hose length may be connected to any other similar diameter hose, pumper truck, fire hydrant, or similar fixed connection. This saves time and manpower, since it is common for hose to be quickly connected or disconnected during the fighting of a fire.

Coupling rims are often provided with protruding lugs arranged so that the lugs across the two coupling rims line up when a seal is achieved. This feature allows the fire fighter to ensure that the joint is fully engaged in low-visibility conditions by feeling the coupling rims for proper lug positioning. The lugs are also shaped for receiving a wrench end, should such force be necessary to properly engage the coupling rims. Wrenches are generally needed for connecting and disconnecting hoses of four-inch diameter and larger due to their considerable size and the torque required to facially compress sealing elements to create a water-tight seal.

At the scene of a fire, hose is removed from a fire truck while it is driven down the street. As hose lengths up to 600 feet are not uncommon, random directional kinks or twists are inevitably formed in the hose as it falls from the truck. This creates a potentially dangerous situation when the hose is pressurized. As the end of a hose is connected to a stationary object, i.e., a pumper truck, heavy distribution manifold, or fire hydrant, when air is displaced through the filling hose, the hose turns in the direction of the kinks that formed when the hose was laid. The twisting force imparted to the hose may be strong enough to loosen, or even disconnect, the coupling.

Perhaps the most dangerous situation occurs when the hose is fastened to a stationary object whose one coupling rim is substantially fixed with respect to the other coupling rim. During pressurization, one kink in the hose can cause a twisting force capable of rotating the relatively less fixed coupling rim, causing separation from the fixed coupling rim. If this occurs in a counterclockwise direction, the rotating line can blow off the stationary object to which it was attached, causing damage to fire fighters, bystanders, and property. Large manifolds have even turned over as a result of such force.

Even if the kinks are removed before the hose is pressurized, a twisting force can still develop as a result of the direction of the weave of the hose, itself. As different hose-makers weave in different directions and some fire departments own hoses from more that one manufacturer, it is difficult, if not impossible, to anticipate the direction the force will take in order to compensate with a coupling rotatable in the opposite direction.

Once the hose is pressurized with water, the danger is over. This is because the pressure in the line holds the coupling system tightly in place.

The prior art has recognized a need for locking quick-connect, non-threaded hose couplings together to prevent disconnection or loosening of the coupling due to the forces generated during pressurization from random directional kinks. Most locking devices have spring-loaded levers that allow the couplings to be connected by springing out of the locked position automatically and then automatically latching into place when the connection is complete. However, disconnection of non-threaded hose couplings with locking devices is tricky at best. Typically, two wrenches must be turned in opposing directions while depressing both locking devices. If one or both locking devices are not depressed, they will bear the forces of wrenching. Fire fighters oftentimes try to remedy unsuccessful decoupling by pushing on the wrenches with all their might. Many prior art locking devices are not strong enough to resist these forces without damage.

There are also a number of prior art locking mechanisms designed solely for use with couplings of the type requiring special end-to-end orientation in order to establish a connection. Many are complex and difficult to operate, especially for fire fighters wearing heavy protective clothing and gloves, which make it difficult to operate couplings or coupling locks requiring great digital dexterity.

Some prior art locking mechanisms are just not durable enough to hold up under the strains of fire fighting. Some employ threaded screws and other metal parts that permanently deform and/or unthread as a result of the forces being placed on the locking mechanism when the coupling is engaged. Use of multiple and often dissimilar metal parts also makes the prior art locking mechanisms prone to corrosion that can make them difficult to operate or cause them to seize.

The configuration and positioning of the prior art locking mechanisms can also make them prone to damage. For example, U.S. Pat. No. 4,648,630 discloses a fire hose coupling locking device that effectively secures a twist-type, high-pressure, quick-connect fire hose coupling from twisting loose when pressure is applied. Typically, it is permanently attached to a friction knob or lug at the top of a collar on the high-pressure outlet side on the fire pumper. It is pivotable about the lug and of sufficient length to span the coupling rims of the high-pressure outlet side to the fire hose and to engage the friction knob or lug on the top of the collar on the fire hose. However, since the locking device is on the outside of the coupling rim, it can easily be damaged or broken off altogether if the device strikes the road or another hard surface while the hose is dropped from the back of a moving fire truck.

The present invention is provided to solve these and other problems.

### SUMMARY OF THE INVENTION

One aspect of the present invention is to provide a safety lock formed of a polymeric material for a water hose coupling.

A further aspect of the present invention is to provide a device for preventing accidental releasing rotation of one elongated conduit with another elongated conduit when the conduit ends are aligned and connected to one another with a first and a second coupling. The first and second couplings work together to create a water-tight seal. The first coupling has a solid post extending from and integral with the coupling and a support surface. There is a polymeric, substantially L-shaped lever positioned adjacent the support surface, and pivotable about the solid post.

Yet another object of the present invention is to provide a device for preventing accidental releasing rotation of one elongated conduit with another elongated conduit when the conduit ends are aligned and connected to one another with a first and a second coupling. The first and second couplings work together to create a water-tight seal. The first coupling has a support surface and, a substantially L-shaped lever having a longer upper leg and a shorter lower leg. The shorter lower leg is positioned within a distance of 0.05 inches or less to the support surface, such that the lower leg can elastically deform to transfer some of the load to the support surface when the couplings rotate towards a decoupled position and the lever is not depressed.

Still a further object of the present invention is to provide a safety lock for a water hose coupling, the safety lock being formed of a material, which when conditioned to a relative humidity of 50% and tested at a temperature of 73° F., has an elongation at yield of at least 10% and a flexural modulus of at least 100,000 psi.

Other objects, advantages, and aspects of the present invention will become apparent upon reading the following description of the drawings and detailed description of the invention.

### BRIEF DESCRIPTION OF THE DRAWINGS

FIG. 1 is a perspective view of a disengaged coupling system with a safety lock;

FIG. 2 is an exploded view of a coupling with a safety lock;

FIG. 3 is a broken-away view of part of a coupling with a safety lock taken along section line 3-3 of FIG. 4;

FIG. 4 is a side view of an engaged coupling system with a safety lock;

FIG. 5 is a broken-away view of an engaged coupling system with a safety lock;

FIG. 6 is a broken-away view of the inside surface of a coupling rim with a safety lock; and

FIG. 7 is a perspective view of a substantially L-shaped lever.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

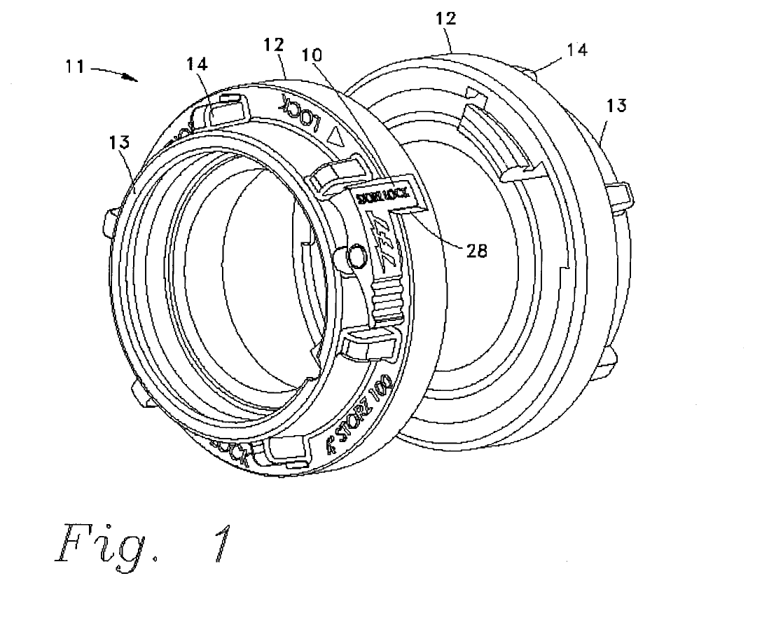

FIG. 1 shows a fire hose coupling safety lock 10 in a disengaged arrangement, installed on a standard quarter-turn, high-pressure, quick-connect androgynous fire hose coupling 11 of the Storz type. Such a coupling 11 can be used to connect a length of hose to any other similar diameter hose, pumper truck, fire hydrant, valve, elbow, adapter, or similar fixed connection. A coupling safety lock 10 is a device for preventing accidental releasing rotation of an engaged coupling 11, thus maintaining a water-tight seal. For the device to work, only one coupling half needs to include a coupling safety lock 10, although both coupling halves may include a coupling safety lock 10.

The coupling 11, itself, has a coupling rim 12 and a collar 13 which are rotationally fixed together. Initially, the coupling rim 12 and collar 13 are free in rotation with respect to the hose and the item the hose is coupled to. However, when the coupling 11 is engaged and water pressure is applied through the coupling 11, the coupling rims 12 and collars 13 become fixed in relation to each other.

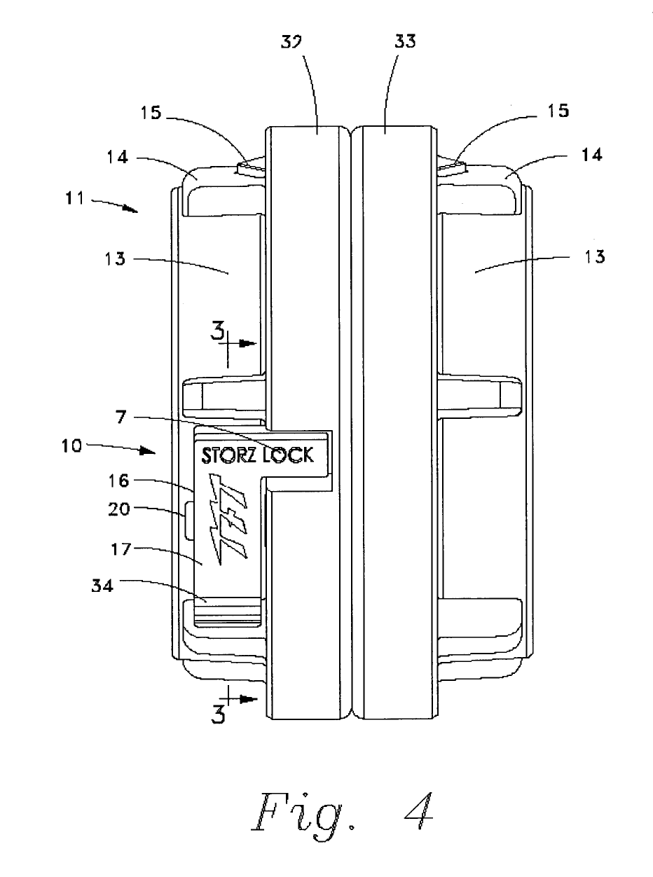

Each collar 13 is equipped with protruding lugs 14 evenly spaced about its circumference. The lugs 14 are designed to receive a wrench end to assist in tightening the coupling 11, should such force be necessary. When the coupling 11 is fully engaged, the lugs 14 are aligned as shown in FIG. 4, demonstrating to the operator that a seal has been achieved. Each coupling half may contain indicator marks 15 on it's exterior that align to indicate that the coupling 11 is fully connected. There is usually one indicator mark 15 per male hook 35. In FIG. 4, the indicator marks 15 are depicted as protruding arrows. Indicator marks 15 in other forms such as grooves on lugs 14 or indentations in coupling rims 12 in the form of a triangle or a circle are also known. Indictor marks 15 are sometimes accented by colored red stickers. Any type of indicator mark 15 may be used with the present invention.

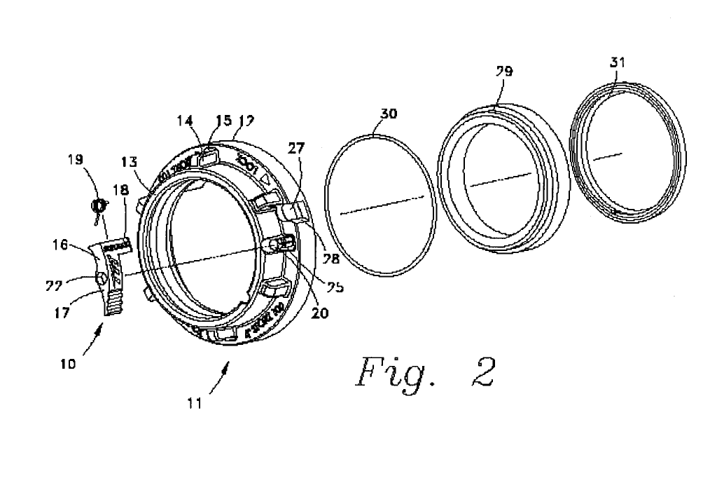

FIG. 2 depicts an exploded view of a coupling 11 and its safety lock 10. The safety lock 10 has a substantially L-shaped lever 16 having a longer upper leg 17 and a shorter lower leg 18. A spring member 19 is used to bias the lever 16 counterclockwise when the lever 16 and spring member 19 are pivotally mounted on solid post 20. Solid post 20 extends from and is integral with the coupling 11. This is important for several reasons. First, making the post 20 and coupling 11 an integral piece obviates the need for a threaded screw or other connector that can bend, unthread, or come loose over time. Second, the post 20 and coupling 11 can be made of the same material, which prevents the corrosion common in other designs from the use of dissimilar metals.

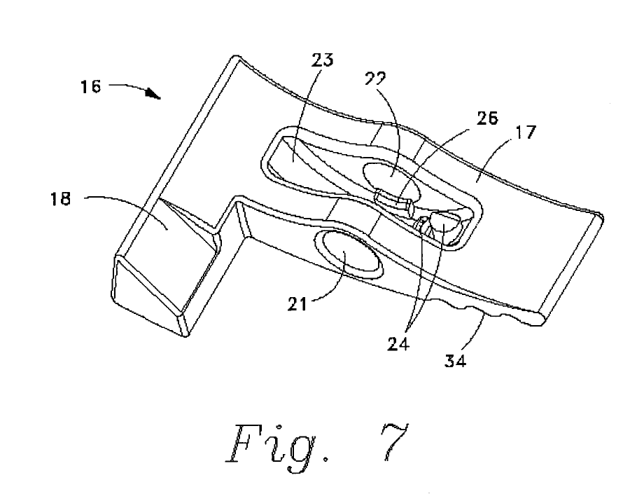

As depicted in FIG. 7, the lever 16 has first and second holes 21, 22 through which the solid post 20 will extend. A space 23 separates the two holes 21, 22 on the lever 16, and the spring member 19 is positioned in the area of this space 23. The spring member 19 is received and held in place by a combination of protrusions 24 formed in the space 23 between the two holes 21, 22 on the lever 16 and an indented portion 25 near the mid-section of solid post 20. A ledge 26 extends from the space 23 near the second hole 22, which ledge 26 engages the indented portion 25 of solid post 20.

When mounted on solid post 20, the lever 16 is positioned inboard of the coupling 11, i.e., no part of the lever 16 extends past the outermost edge of the coupling rim 12 when the safety lock 10 is in the lowest rotational position. This protects the safety lock 10 mechanism from being damaged or broken off during the hose-laying process. However, part of the lever 16 may extend past the outermost edge of the coupling rim 12 during the engagement process or the disengagement process.

When the lever 16 is mounted on the solid post 20, the shorter lower leg 18 extends through an opening 27. Opening 27 is bounded on one side by support surface 28. When assembled, the lateral movement of the lower leg 18 is limited by engagement between solid post 20 and the two holes 21, 22. When extreme decoupling forces are applied to the lever 16, lever 16 elastically deforms allowing the lower leg 18 to make contact with the adjacent support surface 28. Preferably, the lower leg 18 is positioned within a distance of 0.050 inches or less to the support surface 28. This protects both the lever 16 and the solid post 20 from being permanently deformed during use. Because of the proximity of the lower leg 18 and the support surface 28, the lower leg 18 is not allowed to deform beyond a certain point. At that point, the lower leg 18 abuts against the support surface 28. Thus, the support surface 28 is able to bear some of the load that would otherwise be borne solely by the lever 16 and the post 20, preventing both the lever 16 and the post 20 from permanently deforming. It should also be noted that since the solid post 20 is integral with the coupling 11, post 20 is more resistant to deformation than other designs employing threaded screws or other connectors.

The lever 16 can be formed of any material, which when conditioned to a relative humidity of 50% and tested at a temperature of 73° F., has an elongation at yield of at least 10% and a flexural modulus of at least 100,000 psi. The lever 16 can also be formed of a polymeric material. Some polymers that work well are nylon and thermoplastic urethane. These materials lend themselves to this application for several reasons. They are both resilient and durable, so they can withstand the various forces on the system without permanently deforming. Additionally, the use of any nonmetal material, such as a polymer, for the lever 16 obviates the corrosion that is problematic in other designs that use metals for all of their parts.

The coupling 11 of FIG. 2 also includes an insert 29, an O-ring 30 that fits over the insert 29, and a seal 31 that is received in insert 29.

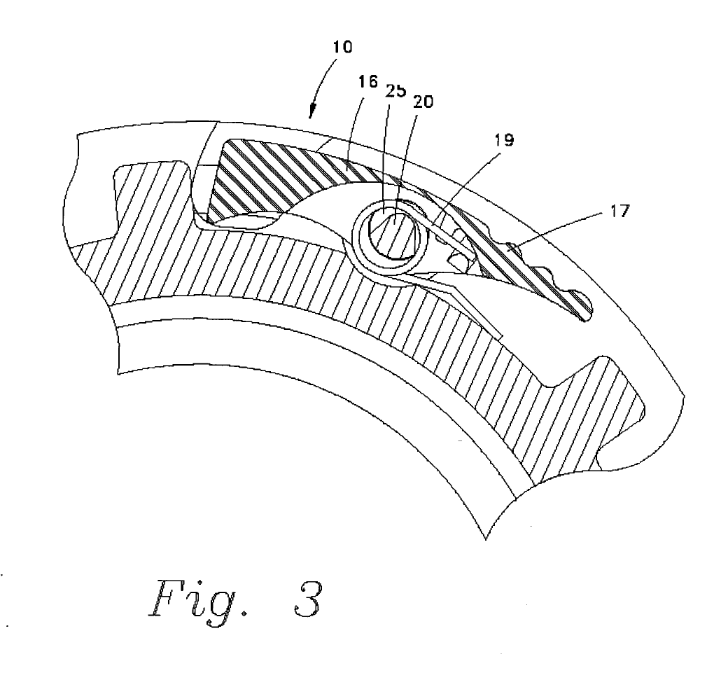

As previously discussed, the lever 16 is mounted with its shorter lower leg 18 extending through the opening 27. Thus, as it is mounted, the solid post 20 first extends through the first hole 21, then through the spring member 19, and then through the second hole 22. A fire hose coupling safety lock 10 is shown mounted on the solid post 20 in FIG. 3. Part of the lever 16 is broken away to show how the spring member 19 wraps around the indented portion 25 of solid post 20 to hold the lever 16 in biased engagement with the solid post 20. Spring member 19 is preferably a torsion spring.

FIG. 4 depicts a first coupling rim 32 having a coupling safety lock 10 in the engaged and locked position with a second coupling rim 33. The operator can tell that the coupling 11 is engaged because the lugs 14 are aligned. To disengage the safety lock 10, the operator need only press down on the outer portion 34 of upper leg 17 to allow unencumbered separation of the coupling rims 32, 33. The coupling safety lock 10 of the present invention will engage any identical coupling rim.

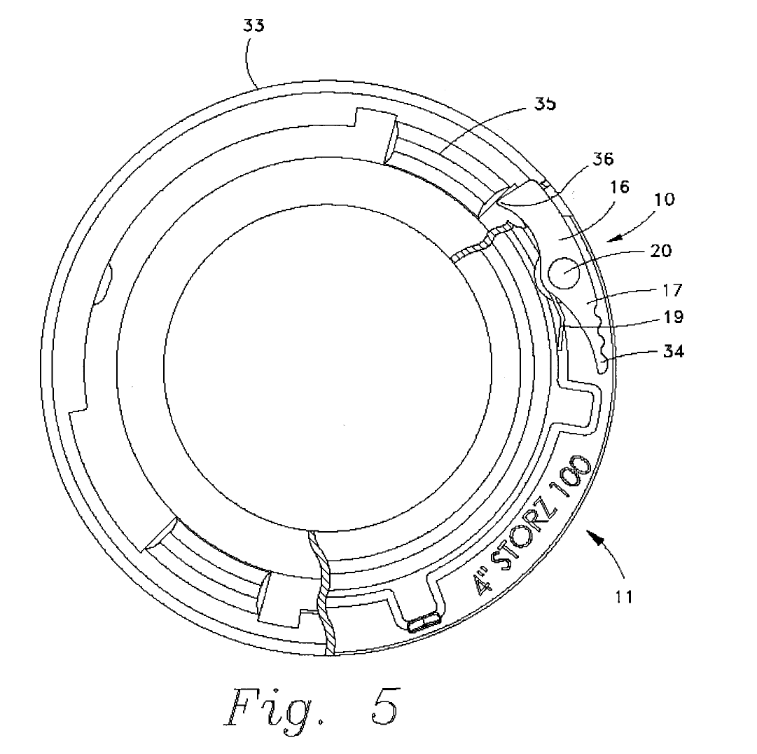

FIG. 5 is a different view of the engaged coupling 11 having a safety lock 10.

Portions of the coupling 11 are broken away to show how the lever 16 prevents uncoupling. As shown in FIG. 5, the male hook 35 of the second coupling rim 33 abuts the distal end 36 of the lever 16, preventing the male hook 35 from moving counterclockwise beyond the lever 16 once the safety lock 10 is engaged.

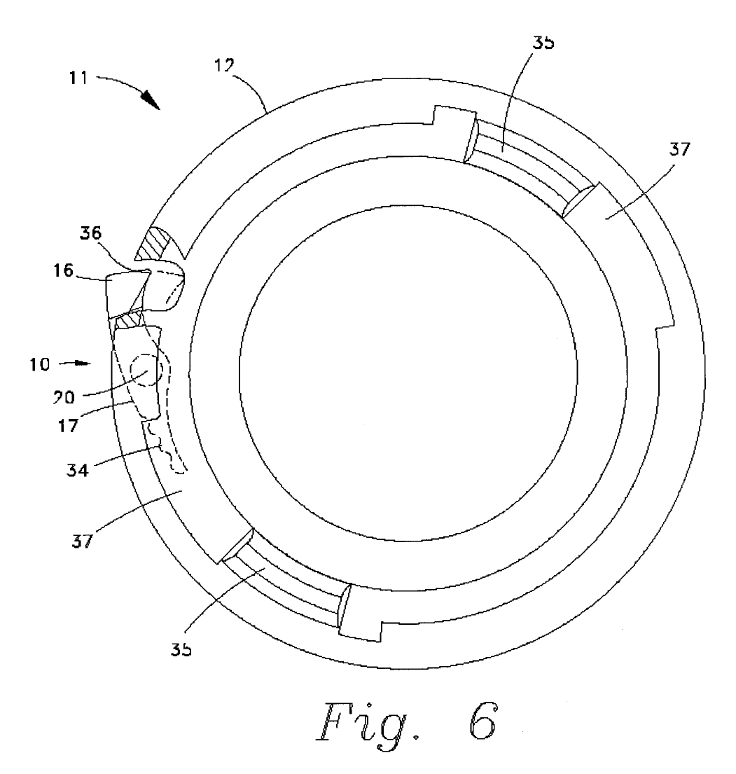

FIG. 6 shows a fragmentary view of the inside of an androgynous coupling rim 12 with a safety lock 10. This androgynous coupling rim 12 has both male hook 35 and female recess 37 connector parts that can engage an identical coupling rim 12. The male hook 35 and female recess 37 of one coupling rim 12 are designed to mate with the female recess 37 and male hook 35 of the other coupling rim 12. When mating two couplings halves together, one coupling rim 12 is rotated with respect to the other coupling rim 12, which movement forces the lever 16 to toggle as shown in FIG. 6 until the male hook 35 passes clear of the lever 16. Then, after the male hook 35 has cleared the lever 16, the lever 16 snaps back into its original position due to the spring bias and the coupling safety lock 10 is engaged. Once the male hook 35 has passed the lever 16 and the lever 16 snaps behind it, the male hook 35 abuts the lever 16 and prevents the coupling 11 from rotating past that position until the operator depresses the outer portion 34 of upper leg 17 to disengage the safety lock 10.

While specific embodiments have been illustrated and described, numerous modifications are possible without departing from the spirit of the invention, and the scope of protection is only limited by the scope of the accompanying claims.

1. A safety lock for a water hose coupling, the water hose coupling being made of a metal, the safety lock being formed of a polymeric material.

2. The safety lock of claim 1, wherein the polymeric material is nylon.

3. The safety lock of claim 1, wherein the polymeric material is thermoplastic urethane.

4. The safety lock of claim 1, wherein the coupling is an androgynous fire hose coupling.

5. The safety lock of claim 1, wherein the safety lock is located inboard of the coupling.

6. The safety lock of claim 1, wherein the safety lock is pivotable about a solid post.

7. The safety lock of claim 1, wherein the coupling includes a support surface, and wherein the safety lock is positioned adjacent to the support surface.

8. The safety lock of claim 7, wherein the safety lock is a substantially L-shaped lever comprising a longer upper leg and a shorter lower leg, and wherein the lateral movement of the shorter lower leg is limited by contact with the adjacent support surface.

9. The safety lock of claim 8, wherein the shorter lower leg is positioned within a distance of 0.05 inches or less to the support surface.

10. A device for preventing accidental releasing rotation of one elongated conduit with another elongated conduit, wherein the conduit ends are aligned and connected to one another with a first and a second coupling, the first and second couplings together creating a water-tight seal, and wherein the first coupling comprises:
a solid post extending from and integral with the coupling, the coupling being made of a metal;
a support surface; and,
a polymeric, substantially L-shaped lever positioned adjacent the support surface, and pivotable about the solid post.

11. The device of claim 10, wherein the couplings are androgynous fire hose couplings.

12. The device of claim 10, wherein the lever is located inboard of the coupling.

13. The device of claim 10, wherein the lever includes an upper leg, and a lower leg, and wherein the lateral movement of the lower leg is limited by contact with the adjacent support surface.

14. The device of claim 13, wherein the lower leg is positioned within a distance of 0.05 inches or less to the support surface.

15. The device of claim 10, wherein the polymer is nylon.

16. The device of claim 10, wherein the polymer is thermoplastic urethane.

17. A device for preventing accidental releasing rotation of one elongated conduit with another elongated conduit, wherein the conduit ends are aligned and connected to one another with a first and a second coupling, the first and second couplings together creating a water-tight seal, and wherein the first coupling is made of a metal and comprises:
a support surface; and,
a substantially L-shaped lever having a longer upper leg and a shorter lower leg, and wherein the shorter lower leg is positioned within a distance of 0.05 inches or less to the support surface.

18. The device of claim 17, wherein the couplings are androgynous fire hose couplings.

19. The device of claim 17, wherein the lever is pivotable about a solid post extending from and integral with the coupling.

20. The device of claim 17, wherein the lever is located inboard of the coupling.

21. The device of claim 17, wherein the lever is formed of a polymeric material.

22. The device of claim 21, wherein the polymeric material is nylon.

23. The device of claim 21, wherein the polymeric material is thermoplastic urethane.

24. A safety lock for a water hose coupling, the water hose coupling being made of a metal, the safety lock being formed of a material, which when conditioned to a relative humidity of 50% and tested at a temperature of 73° F., has an elongation at yield of at least 10% and a flexural modulus of at least 100,000 psi.
